(19) United States
(12) Patent Application Publication
(10) Pub. No.: US 2026/0244148 A1
(43) Pub. Date: Aug. 20, 2026

(54) IMAGE FORMING SYSTEM, POST-PROCESSING DEVICE, FINISHING CONDITION SETTING METHOD, AND STORAGE MEDIUM

(71) Applicant: Konica Minolta, Inc., Tokyo (JP)

(72) Inventors: Hiroshi ISOKAWA, Tokyo (JP); Masaaki UCHIYAMA, Kanagawa (JP); Kenichi YAMADA, Tokyo (JP)

(21) Appl. No.: 19/541,790

(22) Filed: Feb. 17, 2026

(30) Foreign Application Priority Data
Feb. 17, 2025 (JP) 2025-023309

(51) Int. Cl. G03G 15/00

(52) U.S. Cl. CPC G03G 15/6552; G03G 15/6538; G03G 15/6573

(57) ABSTRACT

An image forming system includes: an image forming apparatus that forms an image on a recording medium; a post-processing device that performs post-processing on the recording medium on which the image has been formed, based on a post-processing finishing condition; and a hardware processor that functions as a control device that controls the image forming apparatus and the post-processing device, in which when a quality abnormality occurs in the, the hardware processor sets the post-processing finishing condition for an abnormal recording medium in which the quality abnormality has occurred, the post-processing finishing condition being set such that a size of the abnormal recording medium is different from a size of a normal recording medium in which no quality abnormality has occurred.

### CROSS REFERENCE TO RELATED APPLICATIONS

The present invention claims priority under 35 U.S.C. § 119 to Japanese Patent Application No. 2025-023309 filed on Feb. 17, 2025; the entire content of which is incorporated herein by reference.

### BACKGROUND

### Technological Field

The present invention relates to an image forming system, a post-processing device, a finishing condition setting method, and a storage medium.

### Description of Related Art

An image forming apparatus that forms an image on a recording medium such as a sheet can form the same image on each of a plurality of recording media and eject the recording media. In such an image forming apparatus, when the same image is formed on a plurality of recording media, a quality abnormality such as an image formation failure called “waste” may occur in some recording media.

On the other hand, a plurality of recording media on which images are formed are usually ejected so as to be stacked in the same ejection destination. That is, both the recording medium on which the image is appropriately formed and the recording medium on which the quality abnormality has occurred are ejected to the same tray.

In a case where both of the recording medium on which the image is appropriately formed and the recording medium on which the quality abnormality has occurred are ejected and stacked on the same tray as they are, it is difficult for an operator to visually determine the recording medium on which the quality abnormality has occurred from among the stacked recording media.

Therefore, in recent years, various methods for easily finding waste sheet from among such a plurality of stacked recording media have been proposed. For example, Japanese Unexamined Patent Publication No. 2018-39626 discloses an image forming system in which, when a recording medium is determined to be defective by an inspection machine, a fold line is formed in a region to be cut of the recording medium by an unevenness roller to discriminate waste sheet.

### SUMMARY

However, in the image forming system described in Japanese Unexamined Patent Publication No. 2018-39626, in a case where the number of stacked recording media to be ejected increases, a fold formed on the recording media in which the quality abnormality has occurred may be flattened by a weight of the stacked recording media. Therefore, there is a problem that it may be difficult to determine the recording medium on which the quality abnormality has occurred.

Furthermore, in the image forming system described in PTL 1, since the unevenness roller for determining the recording medium on which the quality abnormality has occurred and a control mechanism for controlling driving of the unevenness roller are required, a product cost increases.

Objectives of the present disclosure include providing an image forming system, a post-processing device, a finishing condition setting method, and a storage medium capable of easily determining a recording medium on which quality abnormality has occurred from among a plurality of stacked recording media while suppressing an increase in cost.

In order to achieve at least one of the above-described objectives, an image forming system reflecting one aspect of the present invention includes:
an image forming apparatus that forms an image on a recording medium;
a post-processing device that performs post-processing on the recording medium on which the image has been formed, based on a post-processing finishing condition; and
a control device that controls the image forming apparatus and the post-processing device, in which
when a quality abnormality occurs in the recording medium, the control device sets the post-processing finishing condition for an abnormal recording medium on which the quality abnormality has occurred, the post-processing finishing condition being set such that a size of the abnormal recording medium is different from a size of a normal recording medium on which no quality abnormality has occurred.

A post-processing device reflecting another aspect of the present invention is a post-processing device that performs post-processing on a recording medium on which an image has been formed, based on a post-processing finishing condition, in which
the post-processing is performed such that a size of an abnormal recording medium on which a quality abnormality has occurred is different from a size of a normal recording medium on which no quality abnormality has occurred.

A finishing condition setting method reflecting still another aspect of the present invention includes:
forming an image on a recording medium;
performing post-processing on the recording medium on which the image has been formed, based on a post-processing finishing condition; and
when a quality abnormality occurs in the recording medium, setting the post-processing finishing condition for an abnormal recording medium in which the quality abnormality has occurred, the post-processing finishing condition being set such that a size of the abnormal recording medium is different from a size of a normal recording medium in which no quality abnormality has occurred.

A non-transitory computer-readable storage medium reflecting yet another aspect of the present invention stores therein a program for causing a computer to execute the above finishing condition setting method.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of the configuration of an image forming system according to the present Embodiment 1;

FIG. 2 is a block diagram illustrating a main part of a control system of the image forming system according to the present Embodiment 1;

FIG. 3 is a functional block diagram illustrating an example of a configuration of the controller of FIG. 2;

FIG. 4 is a schematic diagram for explaining a first example of the post-processing according to the present Embodiment 1;

FIG. 5 is a schematic diagram for explaining a second example of the post-processing according to the present Embodiment 1;

FIG. 6 is a schematic diagram for explaining a third example of the post-processing according to the present Embodiment 1;

FIG. 7 is a schematic diagram for explaining the fourth example of the post-processing according to the present Embodiment 1;

FIG. 8 is a schematic diagram for explaining a fifth example of the post-processing according to the present Embodiment 1;

FIG. 9 is a flowchart showing an example of the flow of the finishing condition setting processing according to the present Embodiment 1;

FIG. 10 is a flowchart illustrating another example of the flow of the finishing condition setting processing according to the present Embodiment 1; and

FIG. 11 is a schematic diagram illustrating the post-processing finishing on an abnormal sheet in a case where an ejection destination of the sheet is set to a sheet ejection tray of a sheet ejection section.

### DETAILED DESCRIPTION OF EMBODIMENTS

Hereinafter, one or more embodiments of the present invention will be described with reference to the drawings. However, the scope of the invention is not limited to the disclosed embodiments.

In the drawings, components denoted by the same reference numerals are the same or equivalent components, and this is common throughout the specification. An image forming system according to the present embodiment is capable of forming an image on a sheet (recording medium) such as a cut sheet of paper.

### Embodiment 1

### Configuration of Image Forming System 1

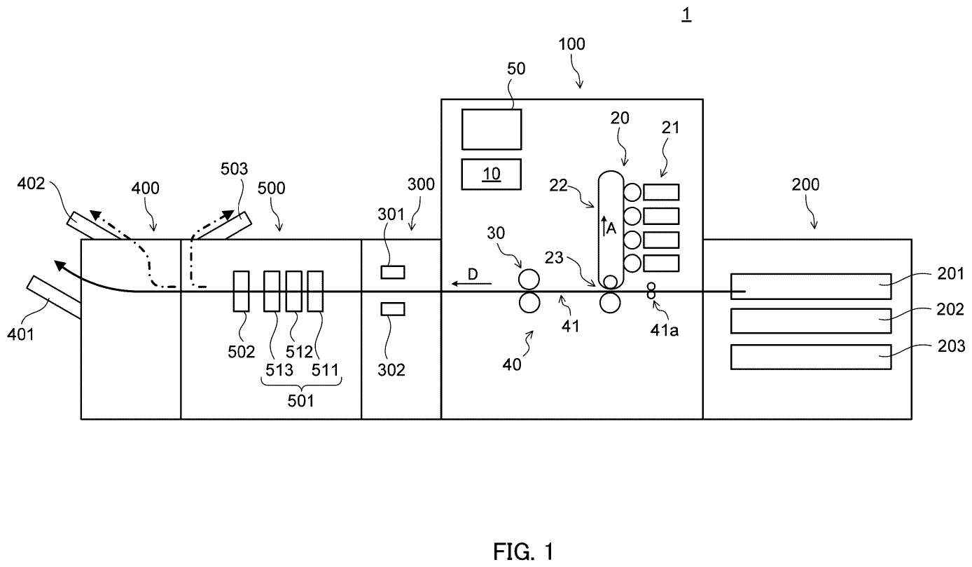

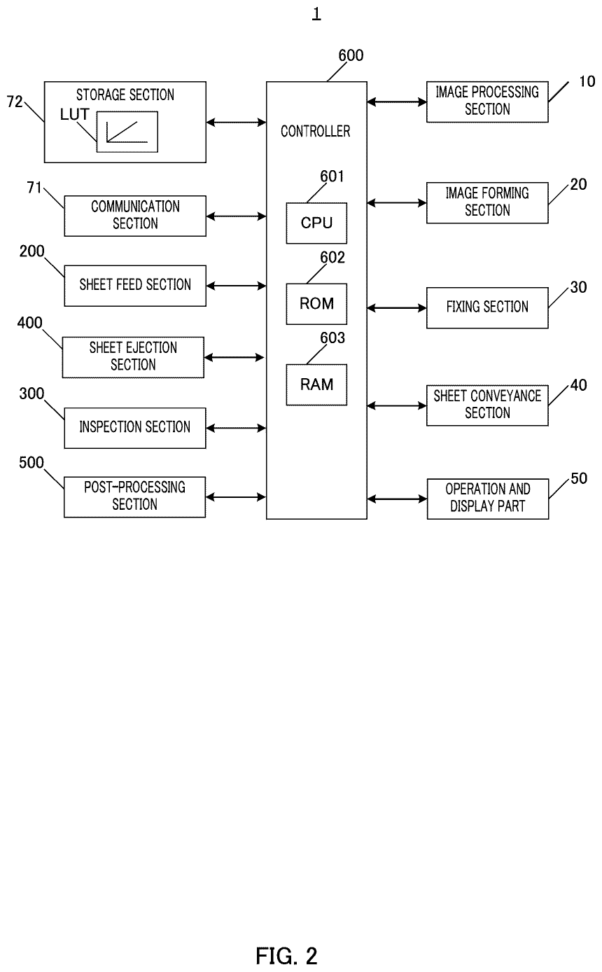

FIG. 1 is a schematic diagram illustrating an example of a configuration of an image forming system 1 according to the present Embodiment 1. FIG. 2 is a block diagram illustrating a main part of a control system of the image forming system 1 according to the present Embodiment 1. As shown in FIG. 1, the image forming system 1 includes an image forming apparatus 100, a sheet feed section 200, an inspection section 300, a post-processing section 500, a sheet ejection section 400, and the like.

The image forming apparatus 100 is an intermediate-transfer-method color image forming apparatus utilizing an electrophotographic process technology. That is, the image forming apparatus 100 performs primary transfer of toner images of each of colors of CMYK formed on a photoreceptor to an intermediate transfer member and performs secondary transfer of the toner images to a sheet after the toner images of the four colors are overlapped with each other on the intermediate transfer member, thereby forming an image. Note that CMYK refers to cyan (C), magenta (M), yellow (Y), and black (K). In the following description, formation of an image by the image forming apparatus 100 may be referred to as “printing”.

The image forming apparatus 100 adopts a tandem-system whereby photoreceptors corresponding to the four colors of CMYK are arranged in series in a travel direction of an intermediate transfer member, and the toner images of the respective colors are sequentially transferred onto the intermediate transfer member by a single sequence.

As shown in FIG. 2, the image forming system 1 includes an image processing section 10, an image forming section 20, a fixing section 30, a sheet conveyance section 40, an operation and display part 50, a communication section 71, a storage section 72, a controller 600, a sheet feed section 200, an inspection section 300, a post-processing section 500, a sheet ejection section 400, and the like.

The image processing section 10 includes a circuit and the like that applies image processing to input image data in accordance with initial settings or user settings. The image forming section 20 is controlled on the basis of the image-processed image data.

The image forming section 20 includes an image forming unit 21, an intermediate transfer unit 22, and a secondary transfer unit 23. The image forming unit 21 forms images with toner of the respective color components based on the image data from the image processing section 10. For example, the image forming unit 21 forms an image with color toners of color components of yellow (Y), magenta (M), cyan (C), and black (K).

The image forming unit 21 includes, for each color, an exposure device, a developing device, a photosensitive drum, a charging device, and a drum cleaning device. As the exposure device, the developing device, the photosensitive drum, the charging device, and the drum cleaning device, known techniques can be adopted, and therefore, detailed description thereof is omitted here.

The intermediate transfer unit 22 includes an intermediate transfer belt and the like. The intermediate transfer belt is wound under tension around a plurality of support rollers in a loop form and travels in the direction of arrow A. The support rollers include rollers such as a backup roller, a primary transfer roller, and a drive roller, but these are not illustrated here. The intermediate transfer belt is pressed against the photosensitive drum, and thus the toner image is transferred from the photosensitive drum to the intermediate transfer belt.

Note that the intermediate transfer unit 22 may be configured to include a belt cleaning device having a plate-like cleaning blade or the like that comes into sliding contact with the surface of the intermediate transfer belt. The belt cleaning device removes transfer residual toner and the like remaining on the surface of the intermediate transfer belt after the secondary transfer.

The secondary transfer unit 23 includes a secondary transfer roller and the like. The secondary transfer roller is in pressed contact with the intermediate transfer belt. Thus, a secondary transfer nip is formed between the intermediate transfer belt and the secondary transfer roller.

In the secondary transfer unit 23, when the sheet is conveyed to the secondary transfer nip, the toner images in the respective colors carried on the intermediate transfer belt are collectively transferred onto the sheet. The sheet on which the toner image has been transferred is conveyed toward the fixing section 30 by the secondary transfer roller.

Note that the secondary transfer unit 23 may be a belt-type secondary transfer unit including a secondary transfer belt stretched around a plurality of support rollers, instead of a roller-type secondary transfer unit including a secondary transfer roller.

The fixing section 30 includes a fixing roller and a pressure roller. The fixing roller is heated to a predetermined fixing temperature, and the pressure roller forms a fixing nip for holding and conveying a sheet with the fixing roller. The fixing section 30 applies heating and pressurizing to the conveyed sheet on which the toner image has been secondarily transferred, thereby fixing the toner image on the sheet.

The sheet conveyance section 40 includes a conveyance route section 41 and the like. The conveyance route section 41 is composed of, for example, a path for conveying a sheet, a plurality of conveyance rollers, and a drive motor for rotationally driving these conveyance rollers. The conveyance route section 41 conveys the sheet supplied from the sheet feed section 200 to the secondary transfer unit 23 and the fixing section 30, and then to the sheet ejection section 400.

In the conveyance route section 41, a registration roller pair 41a is provided on the upstream side of the secondary transfer unit 23 in the sheet conveyance direction D. The registration roller pair 41a adjusts conveyance timing and a direction (angle) of the sheet to be conveyed to the secondary transfer unit 23.

The operation and display part 50 may be, for example, a Liquid Crystal Display (LCD) with a touch screen, and functions as an operation and display part. The display part displays various kinds of operation screens, a state of an image, operating status of the respective functions, and the like in accordance with display control signals received from the controller 600. The operation part includes various kinds of operation keys such as a numeric keypad and a start key, accepts various input operation by a user, and outputs an operation signal to the controller 600.

The sheet feed section 200 is arranged on the upstream side of the image forming apparatus 100 in the sheet conveyance direction D and is connected to the image forming apparatus 100. The sheet feed section 200 includes a plurality of sheet feed trays 201, 202, and 203. In each of the sheet feed trays 201, 202, and 203, sheets (standard sheets or special sheets) identified based on a basis weight, a size, or the like are stored for each type set in advance. The sheet feed section 200 supplies an instructed sheet to the image forming apparatus 100 side on the basis of an instruction from the image forming apparatus 100.

The inspection section 300 is arranged between the image forming apparatus 100 and the post-processing section 500 in the sheet conveyance direction D. The inspection section 300 is connected to the image forming apparatus 100 on the upstream side and is connected to the post-processing section 500 on the downstream side.

The inspection section 300 inspects a state of a sheet on which an image is formed by the image forming apparatus 100. The inspection section 300 includes sensors 301 and 302 that read the sheet conveyed from the image forming apparatus 100.

The sensor 301 is arranged on an upper side of a path along which the sheet is conveyed and is arranged facing a side of the conveyed sheet. Thus, the sensor 301 is configured to read the front surface (upper surface) side of the conveyed sheet.

The sensor 302 is arranged on a lower side of a path along which a sheet is conveyed and is arranged to be face the conveyed sheet. Thus, the sensor 302 is configured to read the back surface (lower surface) side of the conveyed sheet.

As the sensors 301 and 302, for example, a Charge Coupled Device (CCD), a Contact Image Sensor (CIS), or the like is used. In addition, as the sensors 301 and 302, a line sensor, for example, a line scanner, a line sensor camera, or the like, which extends over a width equal to or greater than the width of the sheet (the width in the direction orthogonal to the sheet conveyance direction D) is used.

The sensors 301 and 302 read the image formed on the sheet. Here, as an example, the inspection section 300 is configured to include the sensors 301 and 302 which read both surfaces (front and rear surfaces) of the sheet, but is not limited thereto, and may be configured to include only the sensor 301 which reads one surface (front surface) of the sheet, for example.

The inspection section 300 reads the image formed on the sheet by the sensors 301 and 302 and acquires, as inspection information, information on the sheet such as the sheet and the formed image. Upon acquiring the inspection information, the inspection section 300 transmits the acquired inspection information to the controller 600 to be described later. Then, the controller 600 determines the presence or absence of a quality abnormality in the sheet.

The quality abnormality is so-called “waste” and includes, for example, a failure in image formation on a sheet and a failure in sheet conditions such as sheet size. In the following description, the quality abnormality or a sheet in which the quality abnormality has occurred may be referred to as “waste”.

The sheet ejection section 400 is arranged on the downstream side of the post-processing section 500 in the sheet conveyance direction D and is connected to the image forming apparatus 100 via the inspection section 300 and the post-processing section 500. The sheet ejection section 400 includes a sheet ejection tray 401 and a purge tray 402 and performs sheet ejection of the conveyed sheet to the sheet ejection tray 401 or the purge tray 402. The sheet ejection section 400 corresponds to an “ejection device” of the present disclosure. Furthermore, the sheet ejection tray 401 corresponds to a “first ejection tray” of the present disclosure.

The sheet ejection tray 401 ejects a sheet on which an image has been formed by the image forming apparatus 100. The purge tray 402 ejects, for example, the sheet of which the quality abnormality has occurred as found through the inspection by the inspection section 300. Sheet ejection to the sheet ejection tray 401 and the purge tray 402 is controlled by the controller 600.

Note that when the size of the sheet read by the inspection section 300 does not satisfy a predetermined condition, the sheet ejection section 400 may eject the sheet that does not satisfy the predetermined condition from the purge tray 402, as indicated by a chain line arrow in FIG. 1.

The post-processing section 500 is disposed between the inspection section 300 and the sheet ejection section 400 in the sheet conveyance direction D. The post-processing section 500 is connected to the inspection section 300 on the upstream side and is connected to the sheet ejection section 400 on the downstream side. The post-processing section 500 performs, if necessary, predetermined post-processing on the sheet on which the image has been appropriately formed. For example, the post-processing section 500 performs various types of post-processing such as folding of the sheet, perforation of the sheet, gluing of the sheet, and cutting of the sheet.

In the present Embodiment 1, the post-processing section 500 includes a cutting section 501, a folding section 502, and a sheet ejection tray 503. The post-processing section 500 corresponds to a “post-processing device” of the present disclosure. Furthermore, the sheet ejection tray 503 corresponds to a “second ejection tray” of the present disclosure.

The cutting section 501 cuts the sheet inspected by the inspection section 300 for the presence or absence of quality abnormality. The cutting section 501 includes a cutter 511, a slitter 512, and a trimmer unit 513 on the conveyance route.

The cutter 511 is arranged on a lateral side of the conveyance route of the sheet and cuts the sheet along a direction orthogonal to the conveyance direction of the sheet. The slitter 512 is arranged on the conveyance route of a sheet and cuts the sheet along the conveyance direction of the sheet. The trimmer unit 513 is arranged on the conveyance route of the sheet and cuts the sheet into a planar shape so as to trim the sheet along the conveyance direction of the sheet. Operations of the cutter 511, the slitter 512, and the trimmer unit 513 are controlled by the controller 600.

The configuration of the cutting section 501 described above is an example and is not limited to this example. As the cutting section 501, for example, some of the cutter 511, the slitter 512, and the trimmer unit 513 described above may be provided, or other components may be provided.

The sheet ejection tray 503 ejects the sheet subjected to post-processing. At this time, the sheet subjected to the post-processing is normally ejected to the sheet ejection tray 503 regardless of whether the sheet is a sheet in which no quality abnormality has occurred or a sheet in which the quality abnormality has occurred.

The controller 600 is connected to the image processing section 10, the image forming section 20, the fixing section 30, the sheet conveyance section 40, the operation and display part 50, the communication section 71, the storage section 72, the sheet feed section 200, the inspection section 300, the post-processing section 500, and the sheet ejection section 400. The controller 600 gives various instructions to these components to perform predetermined processing. In the present Embodiment 1, the controller 600 performs finishing condition setting processing. Details of the finishing condition setting processing will be described later. The controller 600 corresponds to a “control device” of the present disclosure.

The controller 600 includes a Central Processing Unit (CPU) 601, a Read Only Memory (ROM) 602, and a Random Access Memory (RAM) 603. The CPU 601 reads a program corresponding to the processing content from the ROM 602, loads the program in the RAM 603, and centrally controls the operation of each block of the image forming system 1 in cooperation with the developed program. At this time, various data such as a Look Up Table (LUT) stored in the storage section 72 are referred to. The storage section 72 is configured by, for example, a nonvolatile semiconductor memory (so-called flash memory) or a hard disk drive. The CPU 601 is an example of a hardware processor that functions as the controller 600.

The controller 600 transmits/receives various types of data to/from an external device (e.g., a computer) connected to a communication network such as a local area network (LAN), a wide area network (WAN) via a communication section 71. The controller 600 receives, for example, image data transmitted from the external device and forms an image on a sheet on the basis of the image data (input image data). The communication section 71 is constituted by a communication control card such as a LAN card.

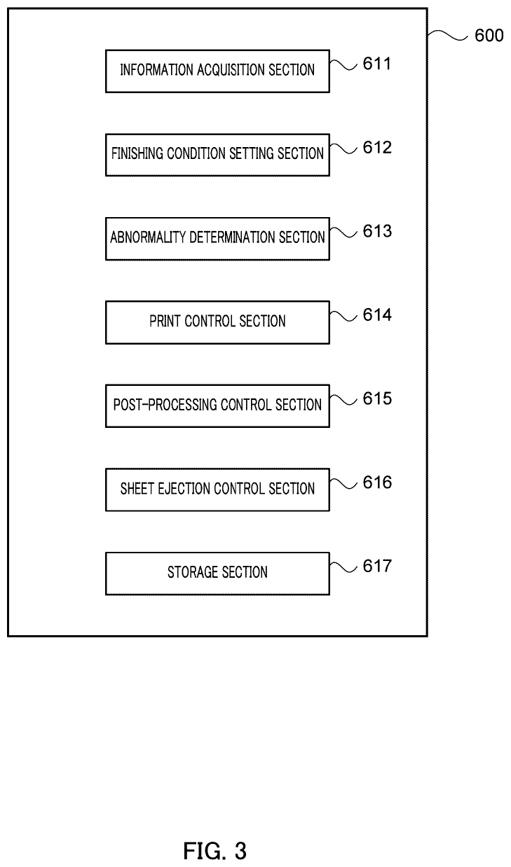

FIG. 3 is a functional block diagram showing an example of the configuration of the controller 600 in FIG. 2. As illustrated in FIG. 3, the controller 600 includes an information acquisition section 611, a finishing condition setting section 612, an abnormality determination section 613, a print control section 614, a post-processing control section 615, a sheet ejection control section 616, and a storage section 617.

The information acquisition section 611 acquires various kinds of information. For example, the information acquisition section 611 acquires a print job when performing printing on a sheet. The print job is data including information about printing, such as an image to be formed at the time of printing, the sheet type, and the content of post-processing such as the type of cutting. Furthermore, the information acquisition section 611 acquires inspection information obtained when the inspection section 300 inspects the sheet.

The finishing condition setting section 612 sets post-processing finishing conditions based on the print job. Furthermore, when the quality abnormality of the sheet occurs, the finishing condition setting section 612 sets the post-processing finishing conditions so as to change the post-processing finishing for the sheet on which the quality abnormality has occurred. The post-processing finishing conditions are information indicating conditions for post-processing to be performed on a sheet on which an image has been formed by the post-processing section 500. The post-processing finishing condition includes, for example, a configuration used for the post-processing finishing such as the cutter 511 and the slitter 512, a use condition thereof, and the like.

The abnormality determination section 613 determines, based on the inspection information obtained from the inspection section 300, the presence or absence of the quality abnormality that occurs in the sheet printed by the image forming apparatus 100.

The print control section 614 controls printing on a sheet by image forming apparatus 100. For example, the print control section 614 controls the image forming apparatus 100 to perform printing in accordance with a print job.

The post-processing control section 615 controls the post-processing by the post-processing section 500 on the basis of the set post-processing finishing conditions. In the present Embodiment 1, the post-processing control section 615 controls the post-processing section 500 so as to perform post-processing finishing for making the size of a sheet in which quality abnormality has occurred different from the size of a normal sheet.

The sheet ejection control section 616 controls the sheet ejection section 400 so that a sheet on which printing or the like is performed is ejected onto a predetermined tray.

The storage section 617 stores various kinds of data and the like used in each section of the controller 600.

For example, the storage section 617 stores print jobs and post-processing finishing conditions set based on the print jobs. The storage section 617 also stores inspection information acquired from the inspection section 300.

Note that the controller 600 may be disposed in any of the devices or may be configured separately from the devices. In addition, the controller 600 may be divided for each function and disposed in each device.

### Operation of Image Forming System 1

Operations of the image forming system 1 according to the present Embodiment 1 having the above-described configuration will be described. In the image forming system 1, when an image is formed on a sheet which is a recording medium, the sheet is accommodated in the sheet feed trays 201, 202, and 203 of the sheet feed section 200. Next, the sheet supplied from the sheet feed section 200 is conveyed to the image forming apparatus 100. Printing is performed on the sheet conveyed to the image forming apparatus 100 in the image forming apparatus 100 according to the content of the print job, and the sheet is conveyed to the inspection section 300.

An image formed on the sheet conveyed to the inspection section 300 is read by the sensors 301 and 302, and the presence or absence of quality abnormality in the sheet is inspected. Then, the sheet for which inspection is completed is conveyed to the post-processing section 500. The sheet conveyed to the post-processing section 500 is subjected to predetermined post-processing finishing in accordance with post-processing finishing conditions set based on the print job, and ejected to a sheet ejection tray 503 of the post-processing section 500.

Note that the post-processing finishing is not performed on the printed sheet in some print job. In such a case, the sheet is usually conveyed to the sheet ejection section 400.

The sheet conveyed to the sheet ejection section 400 is ejected to either the sheet ejection tray 401 or the purge tray 402 according to an inspection result by the inspection section 300. For example, in a case where there is no quality abnormality in the sheet on which the image has been formed, the sheet in which no quality abnormality has occurred (hereinafter, appropriately referred to as a “normal sheet”) is ejected to the sheet ejection tray 401. Furthermore, for example, in a case where a quality abnormality has occurred in a sheet on which an image is formed, the sheet on which the quality abnormality has occurred (hereinafter, appropriately referred to as an “abnormal sheet”) is ejected to the purge tray 402. The normal sheet and the abnormal sheet correspond to a “normal recording medium” and an “abnormal recording medium”, respectively, in the present disclosure.

### Determination of Abnormal Sheet

Here, as described above, when the post-processing finishing is performed on printed sheets, the sheets subjected to the post-processing finishing are normally ejected to the same tray, that is, the sheet ejection tray 503 of the post-processing section 500, regardless of whether the sheets are a normal sheets or an abnormal sheets. However, in this case, since both the normal sheet and the abnormal sheet are stacked, the abnormal sheet is mixed in the stacked normal sheets. Therefore, it is difficult for an operator to determine the abnormal sheet.

Therefore, in the present Embodiment 1, the post-processing finishing that is different from the post-processing finishing performed on the normal sheet is performed on the abnormal sheet such that the size of the abnormal sheet after the post-processing finishing is different from the size of the normal sheet, and thus the abnormal sheet can be easily determined from the stacked sheets. At this time, the controller 600 performs finishing condition setting processing of changing the post-processing finishing conditions from the conditions for the normal sheet based on the content of the post-processing finishing for the normal sheet.

Hereinafter, setting of post-processing finishing conditions for an abnormal sheet according to the content of post-processing finishing for a normal sheet will be described with reference to a specific example.

### First Example

The first example is an example of a case where four side cutting is performed as the post-processing finishing on the normal sheet. Four side cutting is to cut both ends of the sheet in the conveyance direction and the direction orthogonal to the conveyance direction, respectively, to produce one sheet on which post-processing finishing has been performed (hereinafter, appropriately referred to as “finished sheet”). Note that in the following description, a “conveyance direction of a sheet” may be referred to as a “feed direction (FD)” and a “direction orthogonal to the conveyance direction of the sheet” may be referred to as a “cross direction (CD)”.

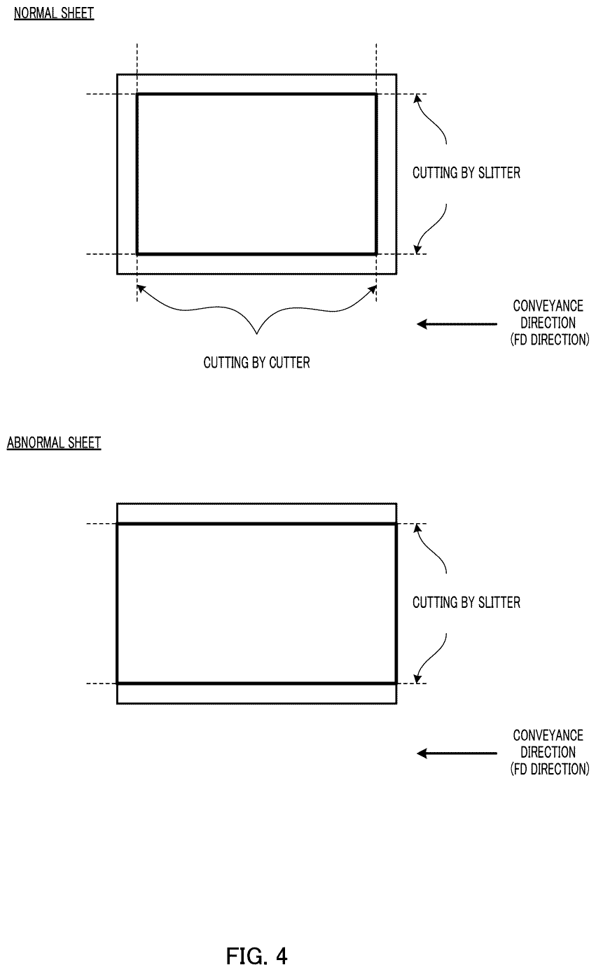

FIG. 4 is a schematic diagram for explaining the first example of the post-processing according to the present Embodiment 1. FIG. 4 illustrates a state in which four side cutting as post-processing finishing is performed on a normal sheet, and a state in which post-processing finishing different from that for the normal sheet is performed on an abnormal sheet.

In the first example, the post-processing finishing conditions are set such that the slitter 512 is used when the sheet is cut in the FD direction and the cutter 511 is used when the sheet is cut in the CD direction in a case where four side cutting is performed as the post-processing finishing on the normal sheet.

On the other hand, when the post-processing finishing is performed on the abnormal sheet, the post-processing finishing conditions are changed so that the length of the finished sheet in the FD direction is longer than the length of the normal sheet. Specifically, the post-processing finishing conditions are changed so that cutting by the cutter 511 is changed from “yes” to “no”. The cutting by the slitter 512 is not changed.

Thus, cutting is not performed on the abnormal sheet in the CD direction, and the abnormal sheet becomes a sheet whose length in the FD direction is longer than the length of the normal sheet in the FD direction. Therefore, even when the finished sheets are ejected and the normal sheets and the abnormal sheets are loaded on the same tray, the abnormal sheet protrudes in the FD direction from among the loaded normal sheets. Therefore, it is possible for the operator to easily discriminate the abnormal sheet by visual observation or the like.

### Second Example

The second example is an example of a case where two sheet cutting is performed as the post-processing finishing on the normal sheet. In the two sheet cutting, both ends of the sheet in the FD direction and the CD direction are cut, and furthermore, the vicinity of the center in the FD direction is cut along the CD direction, thereby producing two finished sheets.

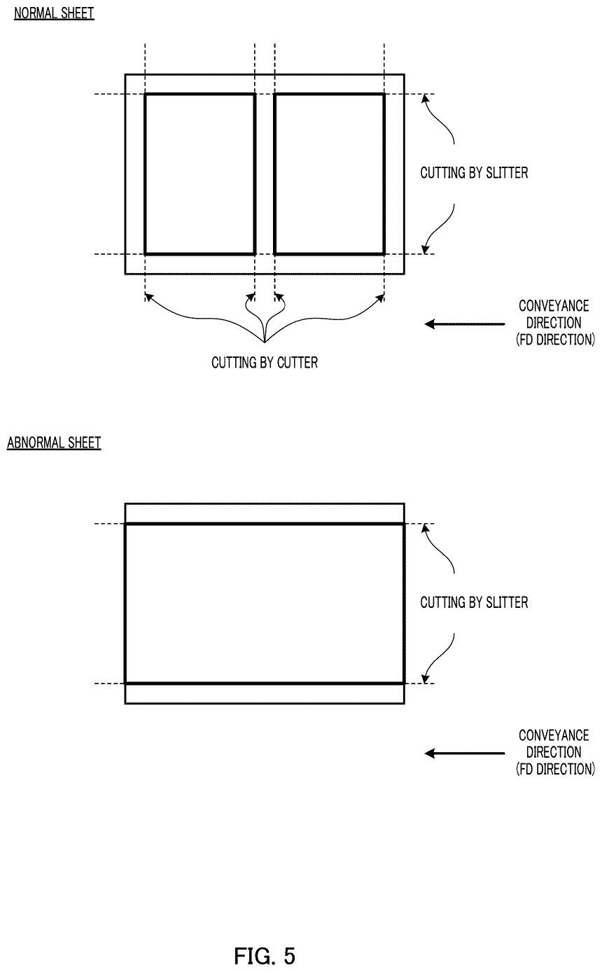

FIG. 5 is a schematic diagram for explaining the second example of the post-processing according to the present Embodiment 1. FIG. 5 illustrates a state in which two sheet cutting is performed on a normal sheet as the post-processing finishing and a state in which post-processing different from that for the normal sheet is performed on an abnormal sheet.

In the second example, in the case of performing two sheet cutting as post-processing finishing on a normal sheet, the post-processing finishing conditions are set such that the slitter 512 is used in cutting the sheet in the FD direction and the cutter 511 is used in cutting the sheet in the CD direction.

On the other hand, when the post-processing finishing is performed on the abnormal sheet, the post-processing finishing conditions are changed so that the length of the finished sheet in the FD direction is longer than the length of the normal sheet. Specifically, the post-processing finishing conditions are changed so that cutting by the cutter 511 is changed from “yes” to “no”. The cutting by the slitter 512 is not changed.

Thus, the abnormal sheet is not cut in the CD direction and becomes one finished sheet whose length in the FD direction is longer than the length of the normal sheet in the FD direction. Therefore, even when the finished sheets are ejected and the normal sheets and the abnormal sheets are loaded on the same tray, the abnormal sheet protrudes in the FD direction from among the loaded normal sheets. Therefore, it is possible for the operator to easily discriminate the abnormal sheet by visual observation or the like.

### Third Example

The third example is an example of a case where multiple sheet cutting is performed as the post-processing finishing on the normal sheet. In multiple sheet cutting, both ends of the sheet in the FD direction and the CD direction and the vicinity of the center are cut to produce three or more finished sheets.

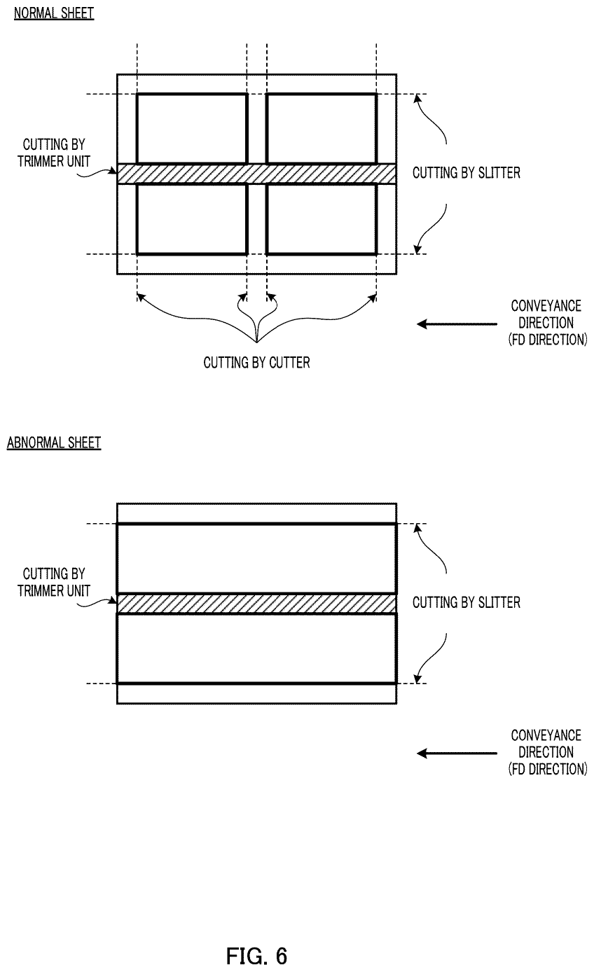

FIG. 6 is a schematic diagram for explaining the third example of the post-processing according to the present Embodiment 1. FIG. 6 illustrates a state in which multiple sheet cutting as the post-processing finishing is performed on the normal sheet and a state in which the post-processing different from that for the normal sheet is performed for the abnormal sheet.

In the third example, the post-processing finishing conditions are set such that the slitter 512 and the trimmer unit 513 are used when the sheet is cut in the FD direction and the cutter 511 is used when the sheet is cut in the CD direction in a case where multiple sheet cutting is performed as the post-processing finishing with respect to the normal sheet.

On the other hand, when the post-processing finishing is performed on the abnormal sheet, the post-processing finishing conditions are changed so that the length of the finished sheet in the FD direction is longer than the length of the normal sheet. Specifically, the post-processing finishing conditions are changed so that cutting by the cutter 511 is changed from “yes” to “no”. Cutting by the slitter 512 and the trimmer unit 513 is not changed.

Thus, the abnormal sheet is not cut in the CD direction and becomes two finished sheets whose length in the FD direction is longer than the length of the normal sheet in the FD direction. Therefore, even when the finished sheets are ejected and the normal sheets and the abnormal sheets are loaded on the same tray, the abnormal sheet protrudes in the FD direction from among the loaded normal sheets. Therefore, it is possible for the operator to easily discriminate the abnormal sheet by visual observation or the like.

### Fourth Example

The fourth example is an example of a case where top and bottom cutting is performed as post-processing finishing on a normal sheet. The top and bottom cutting is to cut both ends of the sheet in the CD direction to produce a finished sheet.

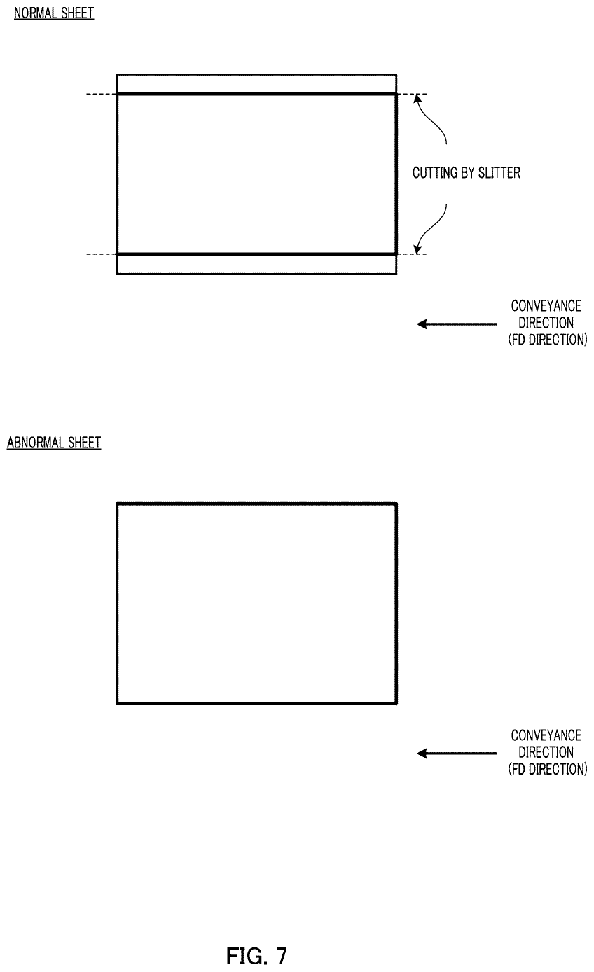

FIG. 7 is a schematic diagram for explaining the fourth example of the post-processing according to the present Embodiment 1. FIG. 7 illustrates a state in which top and bottom cutting as post-processing finishing is performed on a normal sheet and a state in which post-processing finishing different from that for the normal sheet is performed on an abnormal sheet.

In the fourth example, the post-processing finishing conditions are set such that the slitter 512 is used when the sheet is cut in the FD direction in a case where the top and bottom cutting as the post-processing finishing is performed on the normal sheet. Note that under the post-processing finishing conditions, the cutter 511 and the trimmer unit 513 are not used for cutting in the CD direction.

On the contrary, when the post-processing finishing is performed on the abnormal sheet, the post-processing finishing conditions are changed so that the length of the finished sheet in the CD direction is longer than the length of the normal sheet. Specifically, the post-processing finishing conditions are changed so that the cutting by the slitter 512 is changed from “yes” to “no”. Cutting by the cutter 511 and the trimmer unit 513 is not changed. That is, substantially no post-processing finishing is performed on the abnormal sheet in this example.

Thus, cutting is not performed on the abnormal sheet in the FD direction and the CD direction, and the abnormal sheet becomes a finished sheet whose length in the CD direction is longer than the length of the normal sheet in the CD direction. Therefore, even when the finished sheets are ejected and the normal sheets and the abnormal sheets are loaded on the same tray, the abnormal sheet protrudes in the CD direction from among the loaded normal sheets. Therefore, it is possible for the operator to easily discriminate the abnormal sheet by visual observation or the like.

### Fifth Example

The fifth example is an example of a case where tri-folding is performed as the post-processing finishing on the normal sheet. The tri-folding is for creating a finished sheet by tri-folding a sheet.

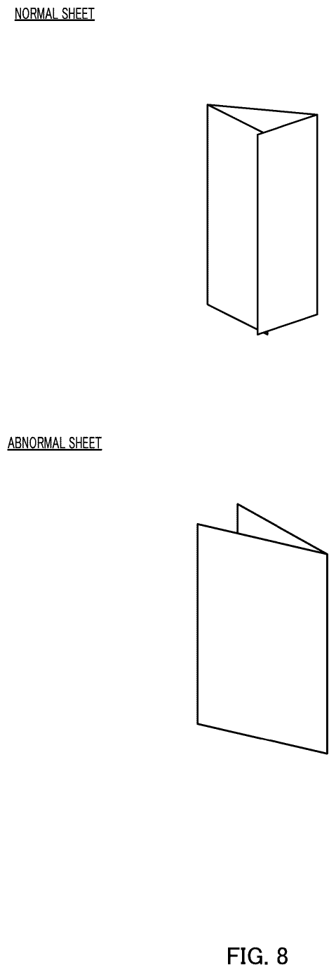

FIG. 8 is a schematic diagram for explaining the fifth example of the post-processing according to the present Embodiment 1. FIG. 8 illustrates a state in which tri-folding as the post-processing finishing is performed on the normal sheet, and a state in which the post-processing different from that for the normal sheet is performed on the abnormal sheet.

In the fifth example, the post-processing finishing conditions are set such that the folding section 502 is used in bending the sheet in the FD direction or the CD direction in a case where tri-folding as the post-processing finishing is performed on the normal sheet. At this time, in the folding section 502, the sheet is folded twice so that the finished sheet is folded in three.

On the other hand, when the post-processing finishing is performed on the abnormal sheet, the post-processing finishing conditions are changed so that the length of the finished sheet in the FD direction or the CD direction is longer than the length of the normal sheet. Specifically, for example, the post-processing finishing conditions are changed so that the number of times of folding by the folding section 502 is changed from “two times” to “one time”.

Thus, the abnormal sheet is folded in two, and becomes a finished sheet whose length in the FD direction or the CD direction is longer than the length of the normal sheet in the FD direction or the CD direction. Therefore, even in a case where the sheets are ejected and the normal sheets and the abnormal sheets are stacked, the abnormal sheet protrudes in the FD direction or the CD direction from among the stacked normal sheets. Therefore, it is possible for the operator to easily discriminate the abnormal sheet by visual observation or the like.

Note that, although it has been described in the fifth example that the post-processing finishing condition is changed so that the number of times of folding by the folding section 502 is one, this is not limited to this example. For example, the post-processing finishing conditions may be changed so that the number of times of folding is “0”, that is, folding is not performed.

As described in the first to fifth examples, in the finishing condition setting processing, when the quality abnormality occurs in the sheet, the post-processing finishing conditions are set such that the size of the abnormal sheet after the post-processing is different from the size of the normal sheet. In a case where the finished sheet is produced by this processing, the abnormal sheet protrudes from the stacked finished sheets. Therefore, even when the normal sheets and the abnormal sheets are stacked when the finished sheets are ejected, the abnormal sheet can be easily discriminated from the stacked normal sheets.

Note that, for example, as in the fourth example, the size of the abnormal sheet can be made different from the size of the normal sheet by not performing the post-processing finishing on the abnormal sheet.

Here, for example, in a case where the post-processing finishing is performed on the normal sheet by using a finishing unit, such as the slitter 512, of the cutting section 501 which is arranged on a conveyance path of the sheet, the finishing unit is retracted so as not to be used when the post-processing finishing is performed on the abnormal sheet without using the slitter 512 or the like.

However, in this case, since a time required for retraction of the finishing unit is required, there is a possibility that the productivity of sheet significantly decreases. Therefore, when the post-processing finishing conditions for the abnormal sheet are changed, it is preferable not to significantly change the positions of the finishing units such as the slitter arranged on the conveyance path of the sheet.

### Finishing Condition Setting Processing

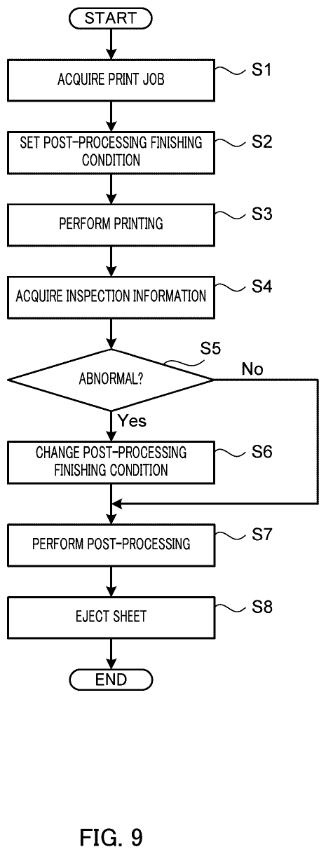

FIG. 9 is a flowchart showing an example of the flow of the finishing condition setting processing according to the present Embodiment 1. Each processing illustrated in this flowchart is executed by each section (see FIG. 3) of the controller 600.

In step S1, the controller 600 information acquisition section 611 acquires a print job. The information acquisition section 611 stores the acquired print job in the storage section 617.

In step S2, the finishing condition setting section 612 sets, based on the acquired print job, post-processing finishing conditions for post-processing to be performed in the post-processing section 500. The finishing condition setting section 612 allows the storage section 617 to store the set post-processing finishing conditions.

When a sheet is conveyed from the sheet feed section 200 to the image forming apparatus 100, in step S3, the print control section 614 controls the image forming apparatus 100 so as to perform printing based on the print job.

When the sheet printed by the image forming apparatus 100 is conveyed to the inspection section 300, in step S4, the information acquisition section 611 acquires inspection information obtained during inspection of the sheet performed by the inspection section 300. The information acquisition section 611 stores the acquired inspection information in the storage section 617.

In step S5, the abnormality determination section 613 reads inspection information from the storage section 617, and determines, based on the read inspection information, the presence or absence of a quality abnormality of the sheet. If it is determined that an abnormality has occurred (step S5: Yes), the process proceeds to step S6. When it is determined that no quality abnormality has occurred (step S5: No), the process proceeds to step S7.

In step S6, the finishing condition setting section 612 changes the set post-processing finishing conditions on the basis of the determination result in step S5. Specifically, when it is determined that the quality abnormality has occurred as a result of the inspection, the finishing condition setting section 612 changes the post-processing finishing condition such that the size of the abnormal sheet is different from the size of the normal sheet. Then, the finishing condition setting section 612 stores the changed post-processing finishing condition in the storage section 617.

In step S7, the post-processing control section 615 controls the post-processing section 500 so that the post-processing is performed on the abnormal sheet so that the size of the abnormal sheet is different from the size of the normal sheet according to the changed post-processing finishing conditions. Next, in step S8, the sheet ejection control section 616 controls the sheet ejection section 400 so that the sheet subjected to the post-processing is ejected onto a predetermined tray (e.g., the sheet ejection tray 401).

When an abnormal sheet is included in the sheets ejected and stacked on a predetermined tray such as the sheet ejection tray 401 in this way, the abnormal sheet is removed by the operator. At this time, since the abnormal sheet has a size different from that of the normal sheet by the post-processing, the operator can determine the abnormal sheet as the sheet and remove the abnormal sheet from the stacked sheets.

### Finishing Condition Setting Processing in Consideration of Recovery Printing

Here, when a quality abnormality of the sheet occurs as found through inspection of the sheet by the inspection section 300, recovery printing for the abnormal sheet can be automatically or manually performed in the image forming system 1 according to the present Embodiment 1. When the recovery of the abnormal sheet is automatically performed, the operation of the image forming system 1 is continued. On the other hand, in a case of manually performing, the operation of the image forming system 1 is temporarily stopped.

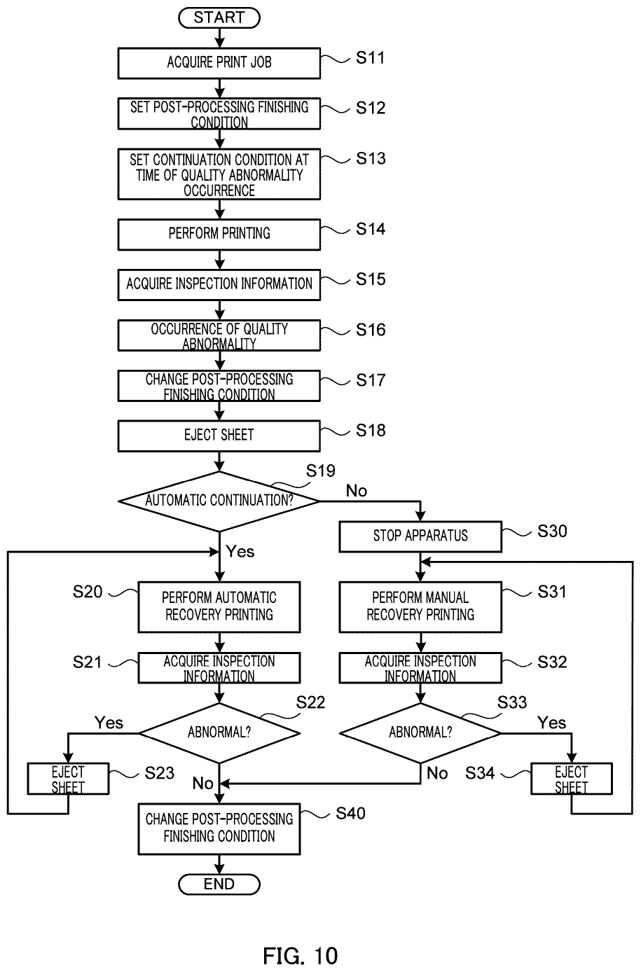

FIG. 10 is a flowchart illustrating another example of the flow of the finishing condition setting processing according to the present Embodiment 1. This example shows a flow of finishing condition setting processing corresponding to the recovery printing which is automatically or manually performed. Each processing illustrated in this flowchart is executed by each section (see FIG. 3) of the controller 600. Note that processing related to post-processing finishing in a case where a sheet quality abnormality has occurred is the same as the processing illustrated in FIG. 9, and therefore description thereof is omitted. Here, a flow of processing when a quality abnormality occurs will be described.

In step S11, the information acquisition section 611 of the controller 600 acquires a print job. The information acquisition section 611 stores the acquired print job in the storage section 617.

In step S12, the finishing condition setting section 612 sets, based on the acquired print job, post-processing finishing conditions for post-processing to be performed in the post-processing section 500. The finishing condition setting section 612 allows the storage section 617 to store the set post-processing finishing conditions.

In step S13, the controller 600 sets a continuation condition as to whether to continue or stop the operation of the apparatus when an abnormality occurs in the sheet.

When a sheet is conveyed from the sheet feed section 200 to the image forming apparatus 100, in step S14, the print control section 614 controls the image forming apparatus 100 so as to perform printing based on the print job.

When the sheet printed by the image forming apparatus 100 is conveyed to the inspection section 300, in step S15, the information acquisition section 611 acquires inspection information obtained during inspection of the sheet performed by the inspection section 300. The information acquisition section 611 stores the acquired inspection information in the storage section 617.

In step S16, the abnormality determination section 613 determines the presence or absence of quality abnormality of the sheet based on the inspection information read from the storage section 617. If it is determined that quality abnormality has occurred, the finishing condition setting section 612 changes the set post-processing finishing conditions in step S17. Specifically, when it is determined that the quality abnormality has occurred as a result of the inspection, the finishing condition setting section 612 changes the post-processing finishing condition such that the size of the abnormal sheet is different from the size of the normal sheet. Then, the finishing condition setting section 612 stores the changed post-processing finishing condition in the storage section 617.

In step S18, the sheet ejection control section 616 controls the sheet ejection section 400 so that a sheet subjected to post-processing is ejected onto a predetermined tray.

Next, in step S19, the controller 600 determines, based on the continuation condition set in step S13, whether the apparatus is in the “automatic continuation” state or the “stop” state. As a result of the determination, when “automatic continuation” is set as the continuation condition (step S19: Yes), the process proceeds to step S20.

In step S20, the print control section 614 executes automatic recovery printing in which recovery printing for an abnormal sheet is automatically performed.

When the sheet printed by the automatic recovery printing is conveyed to the inspection section 300, in step S21, the information acquisition section 611 acquires inspection information on the conveyed sheet from the inspection section 300. The information acquisition section 611 stores the acquired inspection information in the storage section 617.

In step S22, the abnormality determination section 613 reads the inspection information stored in the storage section 617 in step S21, and determines, based on the read inspection information, whether the sheet has a quality abnormality. If it is determined that an abnormality has occurred (step S22: Yes), the process proceeds to step S23.

When it is determined that no quality abnormality has occurred (step S22: No), the process proceeds to step S40.

In step S23, the sheet ejection control section 616 controls the sheet ejection section 400 so that the sheet having the quality abnormality is ejected onto a predetermined tray. Next, the process returns to step S20, and the processes of step S20 to step S23 are repeated until the sheet printed by the automatic recovery printing is determined to be a normal sheet.

On the other hand, in step S19, in a case where “stop” is set as the continuation condition (step S19: No), the process proceeds to step S30. In step S30, the controller 600 stops the operation of the image forming system 1.

At this time, the abnormal sheet included in the sheets ejected and stacked on the predetermined tray is removed by an operator. Since the abnormal sheet has a size different from that of the normal sheet due to the post-processing, the operator can determine the abnormal sheet as a sheet from among the stacked sheets and remove the abnormal sheet.

Next, in step S31, the print control section 614 executes manual recovery printing in which recovery printing for the abnormal sheet is manually performed.

When the sheet printed by the manual recovery printing is conveyed to the inspection section 300, in step S32, the information acquisition section 611 acquires inspection information on the conveyed sheet from the inspection section 300. The information acquisition section 611 stores the acquired inspection information in the storage section 617.

In step S33, the abnormality determination section 613 reads the inspection information stored in the storage section 617 in step S32, and determines, based on the read inspection information, whether or not the sheet has a quality abnormality. When it is determined that a quality abnormality has occurred (step S33: Yes), the process proceeds to step S34. When it is determined that no quality abnormality has occurred (step S33: No), the process proceeds to step S40.

In step S34, the sheet ejection control section 616 controls the sheet ejection section 400 so that the sheet having the quality abnormality is ejected onto a predetermined tray. Next, the process returns to step S31, and processing from step S31 to step S34 is repeated until the sheet printed by manual recovery printing is determined to be normal sheet.

In step S40, the finishing condition setting section 612 changes the set post-processing finishing conditions. That is, the finishing condition setting section 612 changes the post-processing finishing conditions currently set for the abnormal sheet to the conditions for the normal sheet. Then, the finishing condition setting section 612 stores the changed post-processing finishing conditions in the storage section 617.

As described above, in the image forming system 1 according to the present Embodiment 1, when the quality abnormality of the sheet occurs, the finishing condition setting section 612 of the controller 600 sets the post-processing finishing conditions for the abnormal sheet such that the size of the abnormal sheet is different from the size of the normal sheet. Thus, even when the normal sheet and the abnormal sheet are stacked, the size of the abnormal sheet is different from the size of the normal sheet, so that the operator can discriminate the abnormal sheet as the sheet from the stacked sheets.

In addition, since it is not necessary to use a dedicated finishing unit or the like when distinguishing between a normal sheet and an abnormal sheet, it is possible to suppress an increase in cost of the image forming system 1.

### Embodiment 2

Next, the present embodiment 2 will be described. The present embodiment 2 is different from embodiment 1 described above in that the post-processing finishing conditions for the abnormal sheet are changed according to the ejection destination of the sheet. Note that in the present Embodiment 2, the part common among embodiments is denoted by the same numeral or symbol, and detailed description thereof is omitted.

It has been described in the above-described embodiment 1 that the sheet on which the post-processing finishing has been performed is ejected to the sheet ejection tray 503 of the post-processing section 500. On the other hand, in the image forming system 1, when the sheet ejection section 400 is disposed on the downstream side of the post-processing section 500 in the sheet conveyance direction, the sheet subjected to the post-processing finishing can be ejected to the sheet ejection tray 401 or the like of the sheet ejection section 400.

Here, as the drive roller for conveying the sheet in the sheet ejection tray 401 of the sheet ejection section 400, usually, rollers in which a plurality of two or more roller pairs are arranged in parallel in the CD direction are used.

When a finished sheet whose length in the CD direction is shorter than the length between the rollers is conveyed to such a sheet ejection tray 401, the finished sheet is conveyed by one roller pair. In this case, there is a possibility that the finished sheet is not appropriately conveyed due to the occurrence of conveyance skew or the like when the finished sheet is conveyed.

Therefore, when the finished sheet is ejected to the sheet ejection tray 401 of the sheet ejection section 400, the finished sheet needs to have a length in the CD direction longer than the length between the rollers. Therefore, in the present embodiment 2, the post-processing finishing conditions for the abnormal sheet are changed so that the finished sheet is appropriately ejected onto the tray set as the ejection destination of the sheet.

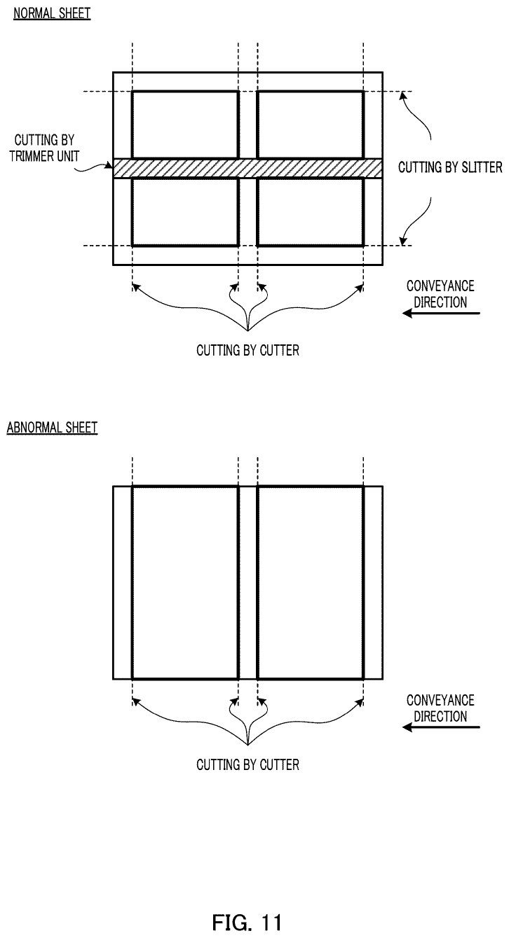

For example, a case where multiple sheet cutting as the post-processing finishing is performed on the normal sheet is considered. FIG. 11 is a schematic diagram illustrating post-processing finishing on an abnormal sheet in a case where the ejection destination of the sheet is set to the sheet ejection tray 401 of the sheet ejection section 400.

As described in embodiment of the third example of the first embodiment (see FIG. 6), in the multiple sheet cutting, both ends in the CD direction and the vicinity of the center are cut, so that the sheet is cut so as to be shorter in the CD direction.

At this time, in a case where the ejection destination of the sheet is the sheet ejection tray 503 of the post-processing section 500, as described in FIG. 6, the abnormal sheet may be cut so that the length in the FD direction is longer than the length of the normal sheet.

On the other hand, in a case where the ejection destination of the sheet is the sheet ejection tray 401 of the sheet ejection section 400, when the post-processing finishing is performed on the abnormal sheet as illustrated in FIG. 6, the length of the finished sheet in the CD direction may become shorter than the length between the rollers. Therefore, there is a possibility that the finished sheet cannot be appropriately conveyed.

Therefore, in this case, as illustrated in FIG. 11, the abnormal sheet is cut such that the length of the abnormal sheet in the CD direction is longer than the length between the rollers and the size of the abnormal sheet is different from the size of the normal sheet. Specifically, for example, the post-processing finishing conditions are changed so that cutting by the slitter 512 and the trimmer unit 513 is changed from “yes” to “no”. Cutting by the cutter 511 is not changed.

Thus, the abnormal sheet is not cut in the FD direction and becomes two finished sheets whose length in the CD direction is longer than the length of the normal sheet in the CD direction. Therefore, even when the finished sheet is ejected onto the sheet ejection tray 401 and the normal sheet and the abnormal sheet are stacked on the same tray, the abnormal sheet protrudes in the CD direction from the stacked normal sheets. Therefore, it is possible to appropriately eject the sheet and to easily determine an abnormal sheet by visual inspection or the like of an operator.

As described above, in the present Embodiment 2, the post-processing finishing condition for the abnormal sheet is set according to the ejection destination of the sheet. Thus, the abnormal sheet having a size suitable for the ejection destination can be ejected, so that the sheet can be appropriately ejected even when the normal sheet and the abnormal sheet are ejected to the same tray.

Although the first and second embodiments have been described above, the present disclosure is not limited to the above-described first and second embodiments and various modifications and applications are possible without departing from the spirit and scope of the present disclosure. For example, the normal sheet and the abnormal sheet are not limited to being ejected onto the same tray, but the respective sheets may be ejected onto different trays.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming system, comprising:
an image forming apparatus that forms an image on a recording medium;
a post-processing device that performs post-processing on the recording medium on which the image has been formed, based on a post-processing finishing condition; and
a hardware processor that functions as a control device that controls the image forming apparatus and the post-processing device, wherein
when a quality abnormality occurs in the recording medium, the hardware processor sets the post-processing finishing condition for an abnormal recording medium in which the quality abnormality has occurred, the post-processing finishing condition being set such that a size of the abnormal recording medium is different from a size of a normal recording medium in which no quality abnormality has occurred.

2. The image forming system according to claim 1, wherein
the hardware processor sets the post-processing finishing condition such that the size of the abnormal recording medium is larger than the size of the normal recording medium.

3. The image forming system according to claim 2, wherein
the hardware processor sets the post-processing finishing condition such that a length of the abnormal recording medium in a conveyance direction is longer than a length of the normal recording medium in the conveyance direction.

4. The image forming system according to claim 2, wherein
the hardware processor sets the post-processing finishing condition such that a length of the abnormal recording medium in a direction orthogonal to a conveyance direction is longer than a length of the normal recording medium in the direction orthogonal to the conveyance direction.

5. The image forming system according to claim 2, wherein
the hardware processor sets the post-processing finishing condition such that a number of times of folding of the abnormal recording medium is smaller than a number of times of folding of the normal recording medium.

6. The image forming system according to claim 1, further comprising:
an ejection device having a first ejection tray to which the recording medium is ejected, wherein
the post-processing device includes a second ejection tray to which the recording medium subjected to the post-processing is ejected, and
the hardware processor sets the post-processing finishing condition for the abnormal recording medium in accordance with an ejection destination of the recording medium.

7. The image forming system according to claim 6, wherein
when the recording medium is ejected to the first ejection tray, the hardware processor sets the post-processing finishing condition such that a length of the abnormal recording medium in a direction orthogonal to a conveyance direction is longer than a length of the normal recording medium in the direction orthogonal to the conveyance direction.

8. The image forming system according to claim 1, wherein
the hardware processor continues operation to perform automatic recovery printing when a quality abnormality occurs in the recording medium.

9. The image forming system according to claim 1, wherein
the hardware processor stops operation when a quality abnormality occurs in the recording medium.

10. The image forming system according to claim 1, wherein
the post-processing device is a cutting apparatus that cuts the recording medium on which an image has been formed.

11. The image forming system according to claim 1, wherein
the post-processing device is a folding apparatus that folds the recording medium on which an image has been formed.

12. A post-processing device that performs post-processing on a recording medium on which an image has been formed, based on a post-processing finishing condition, wherein
the post-processing is performed such that a size of an abnormal recording medium on which a quality abnormality has occurred is different from a size of a normal recording medium on which no quality abnormality has occurred.

13. A finishing condition setting method, comprising:
forming an image on a recording medium;
performing post-processing on the recording medium on which the image has been formed, based on a post-processing finishing condition; and
when a quality abnormality occurs in the recording medium, setting the post-processing finishing condition for an abnormal recording medium in which the quality abnormality has occurred, the post-processing finishing condition being set such that a size of the abnormal recording medium is different from a size of a normal recording medium in which no quality abnormality has occurred.

14. A non-transitory computer-readable storage medium storing therein a program that causes a computer to execute the finishing condition setting method according to claim 13.
